(19) United States
(12) Patent Application Publication
(10) Pub. No.: US 2024/0193444 A1
(43) Pub. Date: Jun. 13, 2024

(54) HIERARCHICAL ARTIFICIAL INTELLIGENCE COMPUTING SYSTEM AND IMPLEMENTATION METHOD THEREOF

(71) Applicant: DELTA ELECTRONICS, INC., Taoyuan City (TW)

(72) Inventors: Yi-Lin TSAI, Taoyuan City (TW); Yu-Hsiang CHENG, Taoyuan City (TW); Jia-Ming WU, Taoyuan City (TW)

(21) Appl. No.: 18/468,982

(22) Filed: Sep. 18, 2023

Related U.S. Application Data
(60) Provisional application No. 63/432,196, filed on Dec. 13, 2022.

(30) Foreign Application Priority Data
Jul. 4, 2023 (CN) 202310813022.9

(51) Int. Cl. G06N 5/04; G06N 20/00

(52) U.S. Cl. CPC G06N 5/04; G06N 20/00

(57) ABSTRACT

A hierarchical artificial intelligence (AI) computing system includes at least one group of a first layer AI subsystems and n second layer AI subsystems. One of the at least one group of a first layer AI subsystems includes m first layer AI subsystems, and each of the m first layer AI subsystems is configured to perform inference based on internal sensing data or a first external sensing data to generate a first inference result; and the n second layer AI subsystems are respectively connected to the at least one group of the first layer AI subsystems, where each of the n second layer AI subsystems is configured to perform inference based on m first inference results, an operation command, and a second external sensing data to generate a second inference result.

### CROSS-REFERENCE TO RELATED APPLICATION

This patent application claims the benefit of U.S. Provisional Patent Application No. 63/432,196, filed Dec. 13, 2022, which is incorporated by reference herein.

### BACKGROUND OF THE DISCLOSURE

### Technical Field

The disclosure generally relates to an artificial intelligence computing system and an implementation method, more particularly to a hierarchical artificial intelligence computing system and the implementation method.

### Description of Related Art

There are numerous methods and frameworks for Artificial Intelligence (AI) and machine learning available in the market. Because frameworks are independent of each other, it is difficult to integrate the frameworks into a single system within a short time. For example, industrial automation systems include various electronic devices with different hardware specifications, so programmers have to customize firmware designs based on customer requirements, machine learning frameworks, and hardware specifications for each electronic device. This results in problems such as a plurality of firmware versions, lengthy development cycles, difficulties in function integration, and challenges in managing and maintaining the system.

Therefore, it is an urgent issue in the related field to provide an AI computation system, related implementation, and deployment methods that solve the aforementioned problems.

### SUMMARY OF THE DISCLOSURE

One of the exemplary embodiments of the present disclosure is to provide a hierarchical artificial intelligence (AI) computing system including at least one group of a first layer AI subsystems, where one of the at least one group of the first layer AI subsystems includes m first layer AI subsystems, and each of the m first layer AI subsystems is configured to perform inference based on internal sensing data or a first external sensing data to generate a first inference result; and n second layer AI subsystems are respectively connected to the at least one group of the first layer AI subsystems, where each of the n second layer AI subsystems is configured to perform inference based on m first inference results, an operation command, and a second external sensing data to generate a second inference result; where m and n are arbitrary positive numbers.

One of the exemplary embodiments of the present disclosure is to provide an implementation method applying for the hierarchical AI computing system including generating an AI model description file by a modeling software; planning at least one function module by a function planning software to establish an AI subsystem; downloading the AI model description file and the AI subsystem by an electronic device to perform initialization; and receiving real-time data by the electronic device and performing an online inference by the AI subsystem.

The hierarchical artificial intelligence computing system and the implementation method of the present disclosure provide the following advantages:
1. By the multi-layered design, the operational process of each layer can be adaptively planned in the computing system, which enhances the specialty of designing AI models for automation control systems. Moreover, the AI models on the same type of electronic devices can be rapidly implemented without retraining the AI models on each electronic device. Additionally, the highest layer of the electronic device collects the inference results from each layer to obtain the overall system inference result.
2. Compared to centralized AI algorithms that require transmitting all operational data to a specified computing device for analysis, which incurs data transmission costs and a large amount of computation time, while the hierarchical design in the present disclosure eliminates unnecessary data transmission costs.
3. The hierarchical design reduces redundant data transmission costs, so the data sampling rate at each layer may be increased. The increased sampling rate improves the efficiency of data feature extraction and the precision of the inference results.
4. The use of standardized AI model description files makes the system compatible with various AI and machine learning methods and frameworks. Programmers are no longer required to customize the firmware designs based on different AI frameworks, which leads to a faster development process and resolves the issue of lengthy development cycles.
5. Programmers can integrate various function modules into an AI inference process or subsystem using the function planning software, which solves problems of difficult function integration, management, and maintenance. The function modules have advantages of reusable, easily portable, and extensible, which can adapt to different manufacturing conditions and high-volume production (repetitive operations) requirements on the production line.

It is understood that both the foregoing general description and the following detailed description are by examples, and are intended to provide further explanation of the disclosure as claimed.

### BRIEF DESCRIPTION OF THE DRAWINGS

FIG. 1 is a schematic diagram of an AI software development system according to an embodiment of the present disclosure.

FIG. 2 is a flowchart illustrating an AI software development method according to an embodiment of the present disclosure.

FIG. 3A illustrates an AI model description file according to an embodiment of the present disclosure.

FIG. 3B illustrates a decision tree description file according to an embodiment of the present disclosure.

FIG. 4 is a flowchart illustrating an initialization of the AI subsystem according to an embodiment of the present disclosure.

FIG. 5 is an architecture diagram illustrating a hierarchical AI computing system according to an embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

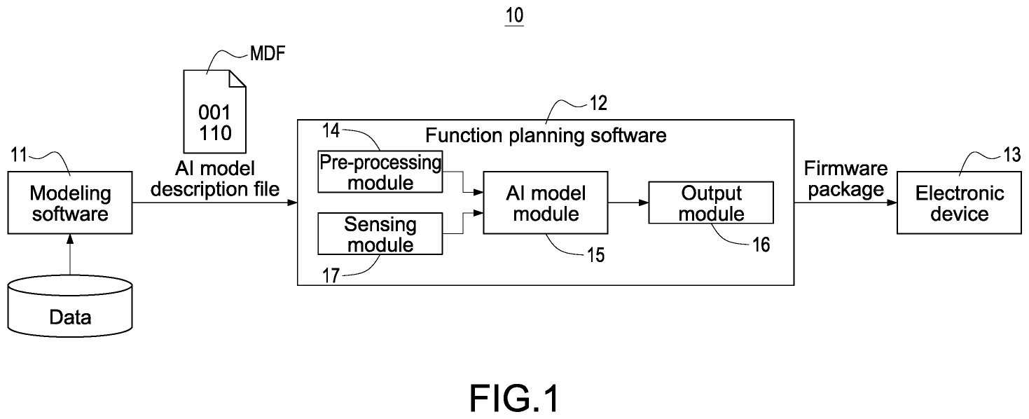

FIG. 1 is a schematic diagram of an artificial intelligence (AI) software development system 10 according to an embodiment of the present disclosure. The AI software development system 10 includes a modeling software 11, a function planning software 12, and an electronic device 13. In structure, the modeling software 11 is coupled to the function planning software 12, and configured to build an AI model and then transform the AI model into an AI model description file MDF that has a common exchange format. The function planning software 12 is coupled to the modeling software 11, and configured to receive the AI model description file MDF and a user operation to plan processes, so the AI model description file MDF and the planned processes are packaged into a firmware package. The electronic device 13 is coupled to the function planning software 12, and configured to download and parse the firmware package to operate the AI model (or called AI inference model) and the planned processes.

In operation, the modeling software 11 collects raw data generated by the electronic device 13 while operating, performs data processing to generate input data, and executes specified algorithms to perform feature extraction and classification on the input data. During model training, the modeling software 11 performs several computation iterations to update model parameters, and the training continues until the inference results of the model meet the expected criteria. Finally, the modeling software 11 converts the well-trained AI model into the AI model description file MDF, and exports the AI model description file MDF to the function planning software 12. The AI model description file MDF includes the trained model architecture and the corresponding parameters.

It should be noted that the AI model description file MDF has a standardized common exchange format, such as the ONNX (Open Neural Network Exchange) format, and is compatible with various artificial intelligence and machine learning methods and frameworks. Consequently, the AI models that are trained using different AI frameworks can be programmed into the standardized AI model description file MDF. The use of the AI model description file MDF eliminates the demand for programmers to customize the firmware designs based on different AI frameworks, so the development process is accelerated and the issue of prolonged development cycles is solved.

Furthermore, the user utilizes the function planning software 12 to design procedures for various application scenarios and download the planned procedures in the form of the firmware package to the electronic device 13. Specifically, the function planning software 12 in FIG. 1 provides an operating environment and a plurality of function modules for the user to arrange a combination, an order, and connection relationships of the plurality of function modules to establish an AI inference process or subsystem. In one embodiment, the function modules include a pre-processing module 14, an AI model module 15, and at least one self-defined function module (such as a sensing module 17, a signal input port, and an output module 16, etc.). The pre-processing module 14 is connected to an input end of the initialized AI model module 15 (e.g., the input layer of a neural network), and is configured to receive and process the input data (real-time data). The real-time data includes at least one of internal sensing data, external data, and operational commands of the electronic device 13. The output module 16 is connected to an output end of the initialized AI model module 15 (e.g., the output layer of the neural network), and is configured to output the inference result of the initialized AI model module 15 (or called the AI model).

In practice, data sources (i.e., the raw data generated when the electronic device 13 is operating), data processing processes, and the trained model (i.e., the AI model description file MDF) that are required for the planned procedure are previously known in the modeling process, then the user can establish the corresponding AI inference processes or subsystems through the function planning software 12 according to the modeling process of the modeling software 11. As a result, the programmers may integrate various function modules into the AI inference process or subsystem by the function planning software 12 to solve problems of function integration difficulties, lacking of manageability, and maintenance.

Furthermore, the function modules provide advantages such as reusability, easy portability, and scalability, which makes the AI models be adaptable to different working conditions and mass production (repetitive operations) requirements on the production line. In industrial automation applications, the same type of the electronic device 13 may be used to manufacture various products, so the programmers may utilize the function planning software 12 to integrate a variety of function modules to adapt to different working conditions or repeatedly use the same function modules to meet the requirement of the mass production (repetitive operations).

In one embodiment, the modeling software 11 may be any modeling software like open-source deep learning frameworks or free software machine learning libraries, such as Caffe2, PyTorch, TensorFlow, Keras, Apache MXNet, tool packages recognized by Microsoft (e.g., Microsoft Cognitive Toolkit, CNTK), and Scikit-learn.

In one embodiment, the function planning software 12 satisfies the standard specification IEC-61131-3 of the International Electrotechnical Commission (IEC) to support the programming system of the electronic device, such as a programmable logic control (PLC), an industrial personal computer (IPC), a computer numerical control (CNC), and a supervisory control and data acquisition (SCADA).

In one embodiment, the modeling software 11 and the function planning software 12 are operable in the electronic device 13 or external devices. For example, when the electronic device 13 is the industrial computer or the human-machine interface (HMI) to have enough computation ability, the modeling software 11 and the function planning software 12 are operable therein. Using external devices to operate the modeling software 11 and the function planning software 12 has the advantage of utilizing more efficient processors which enhances the efficiency of the modeling and planning processes.

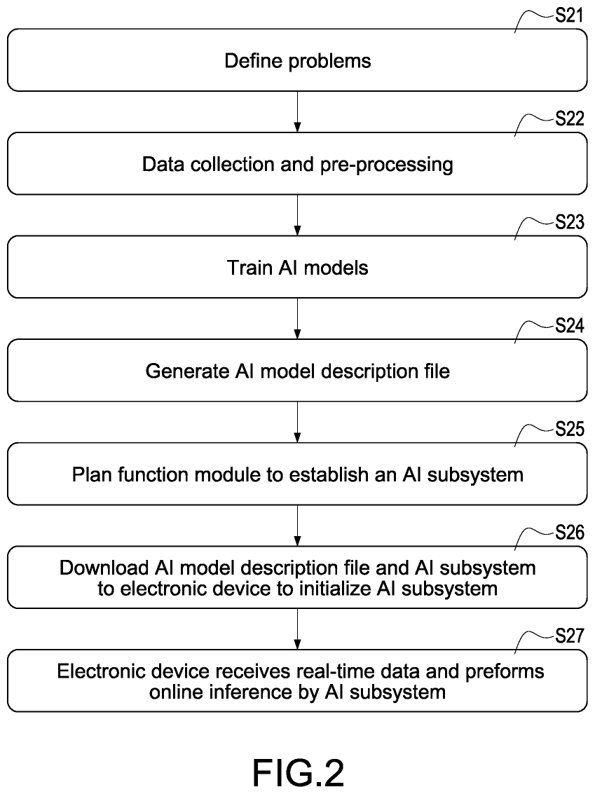

FIG. 2 is a flowchart illustrating an artificial intelligence software development method according to an embodiment of the present disclosure. The artificial intelligence software development method is applied for the AI software development system 10 in FIG. 1 and includes the following steps.
Step S21: Define problems.
Step S22: Data collection and pre-processing.
Step S23: Train the AI models.
Step S24: Generate the AI model description file.
Step S25: Plan the function module to establish an AI subsystem.
Step S26: Download the AI model description file and the AI subsystem to the electronic device 13 to initialize the AI subsystem.
Step S27: The electronic device 13 receives the real-time data and performs an online inference by the AI subsystem.

Specifically, in step S21, the user defines the problem (such as anomaly detection) in order to accordingly design a model architecture, artificial intelligence or machine learning algorithm, and the target function used for training.

In step S22, the data collection and pre-processing are performed based on the defined problem. For example, using sensors to detect data or reading the log files of the electronic device 13, the raw data generated by the electronic device 13 during operation can be collected. The raw data is pre-processed to generate the input data required for training the AI models. In one embodiment, the data pre-processing includes removing noisy data or outliers, data normalization, feature labeling, data integration, and so on. The pre-processed data is a data collection including calibrated data, noise-removed data, and feature-extracted data.

In step S23, the modeling software 11 trains the AI model based on the input data of the pre-processed data. After updating the parameters of the AI model by several computation iterations, the trained model is obtained when the inference result of the AI model meets the requirement.

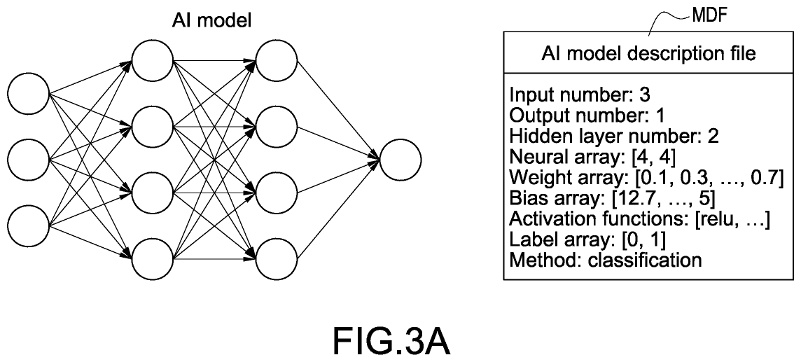

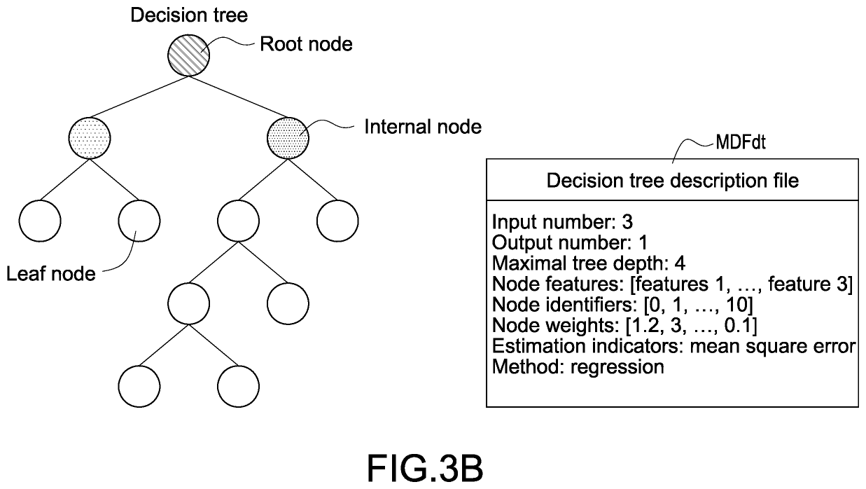

In step S24, after the AI model is completely trained, the modeling software 11 generates the AI model description file. The AI model and the corresponding AI model description file are illustrated in FIG. 3A and FIG. 3B.

In step S25, the function planning software 12 receives user operation to plan the function module and establish the AI subsystem. The user may plan the combination, order, and connection relationships of the plurality of function modules in the operating environment provided by the function planning software 12 to establish the AI subsystem.

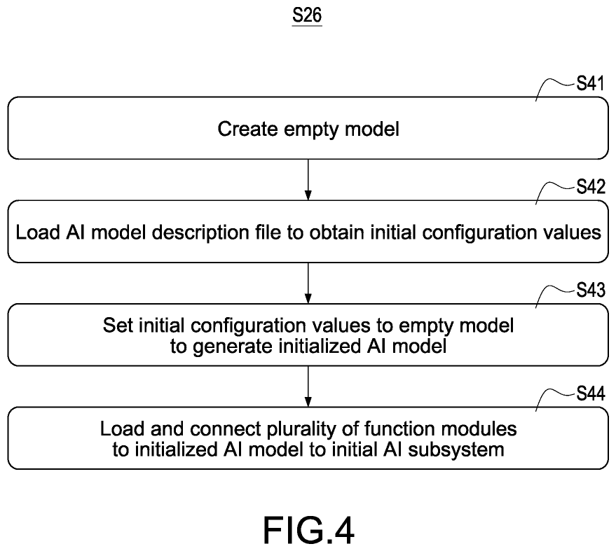

In step S26, after downloading the AI model description file and the AI subsystem, the electronic device 13 performs initialization of the AI subsystem. The initialization process will be described later together with FIG. 4.

In step S27, after the electronic device 13 receives the real-time data, a function module (such as the pre-processing module 14 in FIG. 1) performs data pre-processing to the inputted real-time data to generate the input data. Another function module (such as the AI model module 15 in FIG. 1) uses the input data to perform inference to generate the inference result.

As a result, the AI software development system 10 applied with the artificial intelligence software development method, the AI subsystem can be implemented in the electronic device 13 and perform online inference.

FIG. 3A illustrates an artificial intelligence model description file according to an embodiment of the present disclosure. In this embodiment, the AI model includes one input layer, two hidden layers, and one output layer, where the input layer includes three dimensions, the two hidden layers respectively include four neural cells, and the output layer includes one dimension. The AI model may be programmed into the AI model description file MDF which is the standardized file of the common exchange format. The AI model description file MDF includes an input number, an output number, a hidden layer number, a neural array, a weight array, a bias array, at least one activation function, a label array, a method (or called processing algorithms), and similar description data of the AI model.

In one embodiment, the framework of the artificial intelligence model may be implemented by the Artificial Neural Network (ANN), the Deep Neural Network (DNN), the Convolution Neural Network (CNN), the Recurrent Neural Network (RNN), or other neural networks.

FIG. 3B illustrates a decision tree description file according to an embodiment of the present disclosure. In this embodiment, the AI model is implemented by the decision tree. The decision tree includes one root node, two internal nodes, and eight leaf nodes, where the root node is configured to receive three input values, each internal node and leaf node are configured to output an output value, and the maximum depth of the tree is four. The decision tree is programmed into the decision tree description file MDFdt which is the standardized file of the common exchange format. The decision tree description file MDFdt includes an input number, an output number, a maximal tree depth, node features, node identifiers, node weights, an estimation indicator (such as a mean square error), a method (or called processing algorithms, such as regression), and similar description data of the decision tree.

According to the embodiments of FIG. 3A and FIG. 3B, the AI model can be implemented by any known artificial intelligence and machine learning methods and frameworks, such as the neural network or the decision tree, and the AI model is programmed into the standardized file of the common exchange format. Accordingly, the programmer does not have to customize firmware designs based on different artificial intelligence frameworks, so the development process speeds up and resolves the issue of lengthy development cycles.

FIG. 4 is a flowchart illustrating initialization of the artificial intelligence subsystem according to an embodiment of the present disclosure. The initialization step of the artificial intelligence subsystem (step S26) is performed by the electronic device 13 in FIG. 1 and includes the following steps.
Step S41: Create an empty model.
Step S42: Load the AI model description file to obtain initial configuration values.
Step S43: Set initial configuration values to the empty model to generate an initialized AI model.
Step S44: Load and connect the plurality of function modules to the initialized AI model to initial the AI subsystem.

Specifically, in step S41, the electronic device 13 sets a file type and a file name and allocates a memory space to the created empty model.

In step S42, the electronic device 13 loads and parses the AI model description file to obtain the description data, such as the input number, the output number, the hidden layer number, the neural array, the weight array, the bias array, the at least one activation function, the label array, and the method of the AI model, to be the initial configuration values.

In step S43, the electronic device 13 sets the obtained initial configuration values to the empty model. For example, the electronic device 13 sets the model framework according to the input number, the output number, and the hidden layer number, sets the parameter of each layer according to the neural array, the weight array, the bias array, and sets the activation function of each layer. After the initialization process is finished, the AI model is substantially equivalent to the trained AI model of the modeling software 11.

In step S44, the electronic device 13 loads the plurality of function modules (e.g., the pre-processing module 14 and the output module 16 planned by the function planning software 12) and connects the function modules to each other to generate the initialized AI subsystem.

As a result, by the initialized AI subsystem (step S26), the AI subsystem may be parsed and performed by the electronic device 13 to operate real-time inference computation.

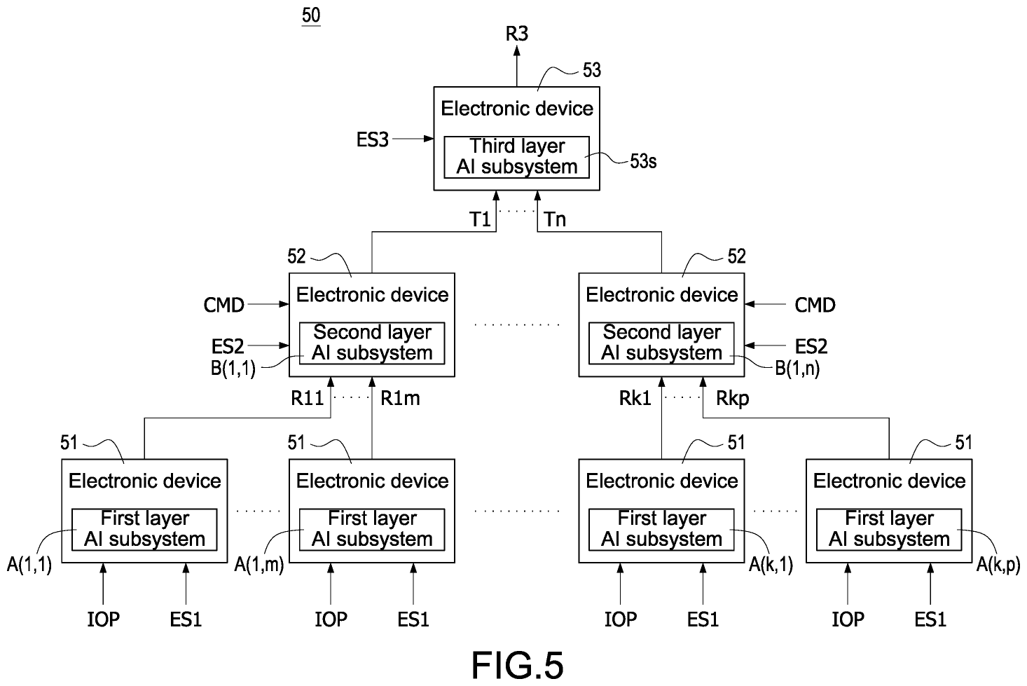

FIG. 5 is a schematic diagram illustrating a hierarchical artificial intelligence computing system according to an embodiment of the present disclosure. In the structure aspect, an artificial intelligence computing system 50 includes at least one group of a first layer AI subsystems A(1,1)˜A(1,m) to A(k,1)˜A(k,p), a plurality of second layer AI subsystems B(1,1)˜B(1,n) and a third layer AI subsystem 53s. Each of the first layer AI subsystem is operated in the electronic device 51, each of the second layer AI subsystem is operated in the electronic device 52, and the third layer AI subsystem 53s is operated in the electronic device 53. In industrial automation applications, a plurality of electronic devices 51 belong to the same layer and include the same or different types of devices, such as motor drivers, servo drives, inverters, and so on. Similarly, a plurality of electronic devices 52 belong to the same layer and include the same or different types of devices, such as programmable logic controllers, human-machine interfaces, and so on. The electronic device 53 may be an industrial computer, a workstation, or the like. Therefore, the plurality of identical or different types of electronic devices 51, 52, and 53 may be combined to form an automated production line.

Each of the at least one group of the first layer AI subsystems includes a plurality of the first layer AI subsystems. In the embodiment, there are k groups of the first layer AI subsystems, wherein one group of the first layer AI subsystems includes m first layer AI subsystems A(1,1)˜A(1,m), and another group of the first layer AI subsystems includes p first layer AI subsystems A(k,1)˜A(k,p), where k, m, p are arbitrary positive integers. Every second layer AI subsystem respectively links to some of the plurality of the first layer AI subsystems. For example, the second layer AI subsystem B(1,1) links to the m first layer AI subsystems A(1,1)˜A(1,m), and the second layer AI subsystem B(1,n) links to the p first layer AI subsystems A(k,1)˜A(k,p). The third layer AI subsystem 53s links to the n second layer AI subsystems B(1,1)˜B(1,n), where n is an arbitrary positive integer.

In operation, as shown in FIG. 5, each of the m first layer AI subsystems A(1,1)˜A(1,m) is configured to perform inference according to internal sensing data IOP and external data ES1 of the electronic device 51, respectively generate first inference results R11˜Rlm, and then transmit the first inference results R11˜R1m to the second layer AI subsystem B(1,1). Similarly, each of the p first layer AI subsystems A(k,1)˜A(k,p) is configured to perform inference according to the internal sensing data IOP and the external data ES1 of the electronic device 51, respectively generate the first inference results Rk1˜Rkp, and then transmit the first inference results Rk1˜Rkp to the second layer AI subsystem B(1,n).

The second layer AI subsystem B(1,1) is configured to perform inference according to the m first inference results R11˜Rlm, the operation command CMD, and the second external data ES2 to generate a second inference result T1. Similarly, the second layer AI subsystem B(1,n) is configured to perform inference according to the p first inference results Rk1˜Rkp, the operation command CMD, and the second external data ES2 to generate the second inference result Tn. Because there are n second layer AI subsystems B(1,1)˜B(1,n), n second inference results T1˜Tn are generated accordingly. The n second inference results T1˜Tn are respectively transmitted to the third layer AI subsystem 53s.

The third layer AI subsystem 53s is configured to perform inference according to the n second inference results T1˜Tn and the third external sensing data ES3 to generate a third inference result R3.

In one embodiment, one of the first layer AI subsystems A(1,1)˜A(1,m) to A(k,1)˜A(k,p) is installed in the motor driver, and the internal sensing data IOP includes at least one of a motor position, a motor current, a motor voltage, and a vibration. Because the motor driver is connected to the motor and configured to control the operations of the motor, the motor driver directly accesses the internal sensing data IOP of the motor. The first inference results R11˜R1m to the Rk1˜Rkp include at least one of a friction, a belt tension, a gear gap, a transmission eccentricity, and a load imbalance.

In one embodiment, one of the second layer AI subsystems B(1,1)˜B(1,n) is installed in the controller. The controller is connected to the motor driver and configured to control the motor driver. The second inference results T1˜Tn include at least one of a machine health status and a processing quality status.

In one embodiment, the third layer AI subsystem 53s is installed in the industrial computer and configured to control the plurality of controllers. The third inference result R3 includes at least one of a production line operating status and a production quality status.

In one embodiment, the operation command CMD received by the first layer AI subsystems A(1,1)˜A(1,m) to A(k,1)˜A(k,p) is the command from the controller for controlling the motor driver. The operation command CMD received by the second layer AI subsystems B(1,1)˜B(1,n) is the command from the industrial computer for controlling the motor driver.

To sum up, the hierarchical artificial intelligence computation system and the implementation method for the hierarchical artificial intelligence computation system provide a multi-layered design for adaptively planning the operational process of the AI subsystem of each layer to enhance the specialty of designing artificial intelligence models in automation control systems and facilitate the rapid implementation of the artificial intelligence models on the same type of the electronic devices without retraining the models on each device.

Furthermore, compared to centralized artificial intelligence algorithms that require transmitting all operational data to a specified computing device for the analysis process and consuming the data transmission costs and the extensive computation time, the present disclosure eliminates unnecessary data transmission by the hierarchical design. The internal sensing data and external data of the electronic device of each layer do not have to be transmitted to other layers for the inference analysis. Only the inference results need to be provided to the electronic devices of other layers for further analysis that reduces the complexity of implementing AI models on a large number of electronic devices. Additionally, the highest-layer electronic device collects the inference results from the AI subsystem of each layer to obtain the overall system inference result.

Because the hierarchical design eliminates unnecessary data transmission costs, the data sampling rate at each layer is increased, the data features are efficiently obtained, and the inference result is obtained with high accuracy.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A hierarchical artificial intelligence (AI) computing system, comprising:
at least one group of a first layer AI subsystems, wherein one of the at least one group of the first layer AI subsystems comprises m first layer AI subsystems, and each of the m first layer AI subsystems is configured to perform inference based on an internal sensing data or a first external sensing data to generate a first inference result; and
n second layer AI subsystems respectively connected to the at least one group of the first layer AI subsystems, wherein each of the n second layer AI subsystems is configured to perform inference based on m first inference results, an operation command, and a second external sensing data to generate a second inference result.

2. The hierarchical AI computing system of claim 1, wherein one of the m first layer AI subsystems is installed in a motor driver, and the internal sensing data comprises at least one of a motor location, a motor current, a motor voltage, and a vibration of the first external sensing data.

3. The hierarchical AI computing system of claim 2, wherein the first inference result comprises at least one of a friction, a belt tension, a gear gap, a transmission eccentricity, and a load imbalance.

4. The hierarchical AI computing system of claim 2, wherein one of the n second layer AI subsystems is installed in a controller, the controller is configured to control the motor driver, and the second inference result comprises at least one of a machine health status and a processing quality status.

5. The hierarchical AI computing system of claim 1, further comprising:
a third layer AI subsystem connected to the n second layer AI subsystems, wherein the third layer AI subsystem is configured to perform inference based on n second inference results and a third external sensing data to generate a third inference result.

6. The hierarchical AI computing system of claim 5, wherein the third layer AI subsystem is installed in an industrial computer and configured to control a plurality of controllers, wherein the third inference result comprises at least one of a production line operating status and a production quality status.

7. An implementation method applying for the hierarchical AI computing system of claim 1, comprising:
generating an AI model description file by a modeling software;
planning at least one function module by a function planning software to establish an AI subsystem;
downloading the AI model description file and the AI subsystem by an electronic device to perform initialization; and
receiving real-time data by the electronic device and performing online inference by the AI subsystem.

8. The implementation method of claim 7, wherein step of downloading the AI model description file and the AI subsystem to perform initialization comprises:
creating an empty model;
loading the AI model description file to obtain a plurality of initial configuration values;
setting the plurality of initial configuration values to the empty model to generate an initialized AI model; and
loading the at least one function module and connecting the at least one function module to the initialized AI model to initialize the AI subsystem.

9. The implementation method of claim 8, wherein the at least one function module comprises:
a pre-processing module connected to an input end of the initialized AI model, and configured to receive and process the real-time data, wherein the real-time data comprises at least one of internal sensing data, external data, and an operation command; and
an output module connected to an output end of the initialized AI model, and configured to output an inference result of the initialized AI model.

10. The implementation method of claim 7, wherein the plurality of initial configuration values of the AI model description file comprises at least one of an input number, an output number, a hidden layer number, a neural array, a weight array, a bias array, at least one activation function, and a method.

11. The implementation method of claim 7, wherein the AI model description file comprises a standardized format of ONNX (Open Neural Network Exchange).

12. The implementation method of claim 7, wherein the function planning software satisfies a standard specification of IEC-61131-3.
